(19) United States
(12) Patent Application Publication
(10) Pub. No.: US 2017/0282389 A1
(43) Pub. Date: Oct. 5, 2017

(54) RAZOR CARTRIDGE WITH FLUID MANAGEMENT

(71) Applicant: The Gillette Company LLC, Boston, MA (US)

(72) Inventors: William Owen Jolley, Spencer, MA (US); Mark Peterson, Reading (GB); Joia Kirin Spooner-Fleming, Jamaica Plain, MA (US); Alison Fiona Stephens, Maidenhead (GB); James Tandy, Singapore (SG); Paul Leslie Warrick, Reading (GB); Jack Anthony Washington, Quincy, MA (US)

(21) Appl. No.: 15/464,754

(22) Filed: Mar. 21, 2017

(30) Foreign Application Priority Data
Mar. 31, 2016 (EP) 16163191.6
Mar. 14, 2017 (EP) 17160796.3

(51) Int. Cl. B26B 21/44

(52) U.S. Cl. CPC B26B 21/446

(57) ABSTRACT

A razor cartridge comprising a housing having elongated skin contacting elements having a plurality of channels extending there through to facilitate fluid flow.

### FIELD OF THE INVENTION

The invention relates to the management of fluid in hair removal devices such as razor cartridges and foils during shaving.

### BACKGROUND OF THE INVENTION

Razor cartridges are typically provided with a guard in front of the blades and a cap behind the blades which contact the skin before and after the blades respectively. The guard and cap may aid to establish the “shaving geometry” i.e. the parameters which determine blade orientation and position relative to the skin and have a strong influence on shaving performance and efficiency of the razor.

The guard is present on the razor cartridge to manage the skin and stretch the skin prior to contact with the blade to ensure optimal contact with the blade without negative skin sensations. The guards are typically provided from an elastomeric or thermoplastic material to further improve skin contact and tactile performance. Recently guards having longitudinal fins formed from such elastomeric materials have been incorporated on the cartridge in order to improve the orientation of the hair in order to maximize cutting efficiency, as described for example in WO 2010/039479 and U.S. 2012/0144675.

In order to provide lubrication to the skin during the shave, a shaving preparation is typically applied to the skin prior to shaving. In addition, the razor cartridge may also be provided with a shaving aid usually present on the cap and/or guard. The shaving aid contains a lubricant typically within a matrix structure, which is designed to release lubricant with water gradually during each shaving occasion and deposit onto the skin. The lubricant is beneficial in reducing the friction between the skin and the blades.

However it has been found that the optimization of the guard performance for skin stretch may impact the performance of the lubricating material from the shaving aid or preparation in that the guard reduces the ability of the lubricating material to contact the skin at the contacting points of the blade and skin.

There is thus a need to provide a razor cartridge which has a guard to provide the desired skin stretch and orientation prior to contact with the blade while ensuring sufficient contact of the fluid, shaving aid or lubricant with the skin to improve shave comfort and reduce skin irritation.

### SUMMARY OF THE INVENTION

A razor cartridge comprising a housing (20) having a proximal end portion (24), a distal end portion (26), and first (28) and second (30) lateral end portions, and at least one blade (22) positioned between said proximal (24) and distal (26) end portions; said housing comprising:
1) A skin contacting bar (40) in front and adjacent said blade, wherein said skin contacting bar (40) has a plurality of rigid projections (42) extending generally perpendicular to said blade;

and
2) An elongated gap (108) adjacent said first guard (40) and generally parallel to said skin contacting bar; and
3) An elongated skin contacting element (60) adjacent said elongated gap (108), wherein said elongated skin contacting element (60) has from 2 to 30 discrete fluid pathway channels (62) preferably extending generally perpendicular to said blade, each channel having a respective fluid inlet (64) and fluid outlet (65) and corresponding land portions (63) in-between said channels, wherein at least one of said land portions, preferably each of said land portions comprises at least one skin stretching means and wherein;
4) Said fluid inlets (64) of said channels (62) are coincident with the edge of the proximal end portion (24) of said housing.

### BRIEF DESCRIPTION OF THE DRAWINGS

FIG. 1 is a top view of one possible embodiment of a shaving razor of the present invention.

FIG. 2a is a detailed top plan view of the cartridge of FIG. 1.

FIG. 2b is a detailed top plan view of an alternative embodiment of a cartridge of the present invention.

FIG. 3 is a partial top plan view of an elongated skin contacting element of the cartridge of FIG. 2b.

FIG. 4A is an enlarged partial top plan view of the cartridge of FIG. 2b.

FIG. 4B is a partial cross section view of the cartridge, taken generally along the line 4-4 of FIG. 2b.

FIG. 5 are cross sectional views of alternative configurations of the channels (62).

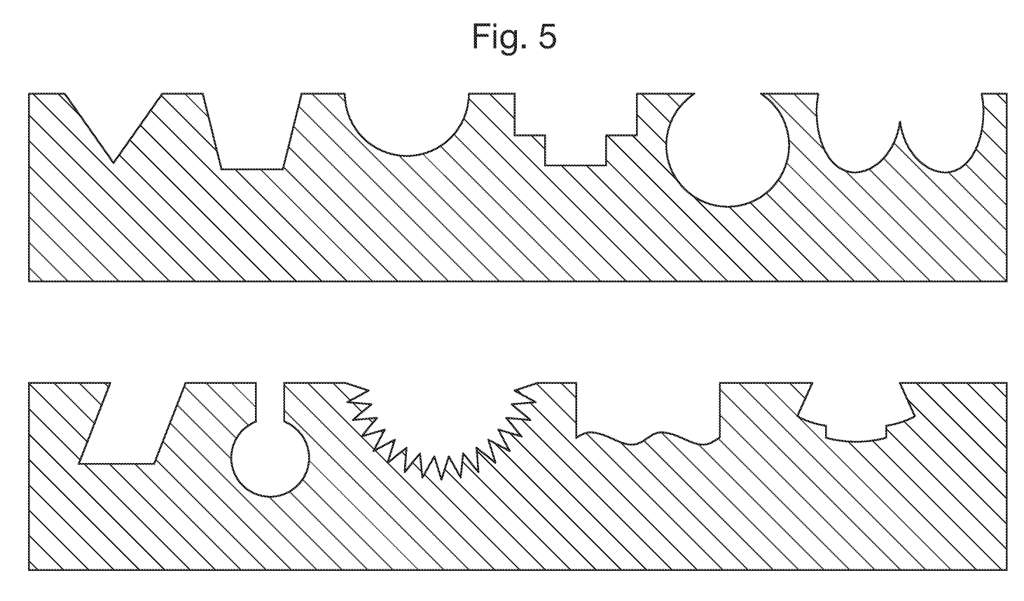

FIG. 6 is a partial top view cut away of an alternative embodiment of a cartridge shown in FIG. 1.

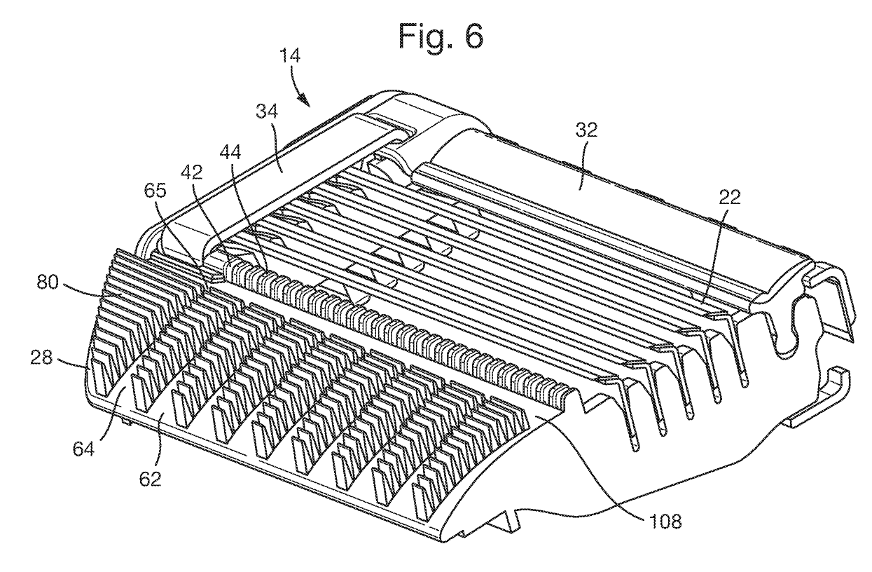

### DETAILED DESCRIPTION OF THE INVENTION

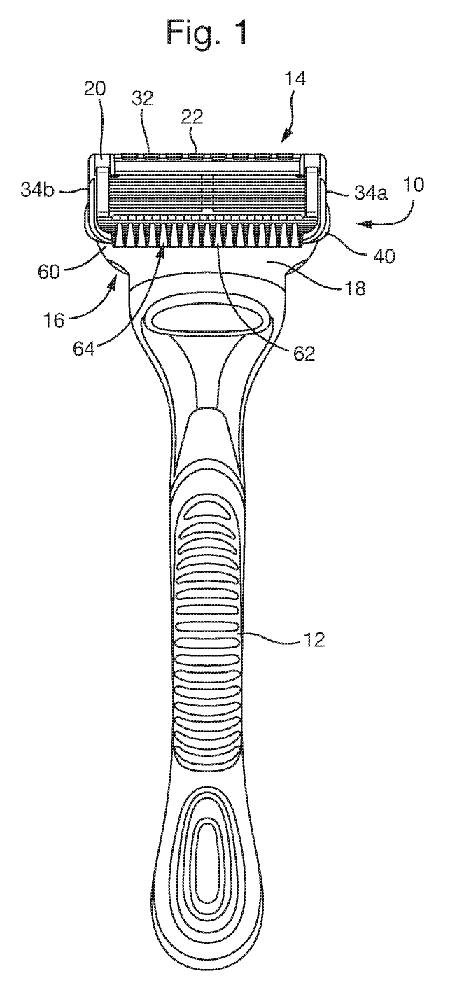

Referring to FIG. 1, one possible embodiment of the present invention is shown illustrating a shaving razor (10) having a handle (12) and a cartridge (14). In certain embodiments, the cartridge (14) may be detached and removed from the handle (12). The cartridge (14) may be fixedly or pivotably mounted to the handle (12). The cartridge (14) may also include an interconnect member (16) to which the cartridge (14) is pivotably mounted about a pivot axis. The interconnect member (16) may include a base (18) which is connected to the handle (12). The cartridge (14) includes a housing (20) that carry one or more blades (22), a cap (32), and an elongated skin contacting element (60). The one or more blades (22) may be mounted within the housing (20) and secured with a pair of clips (34a and 34b). Other assembly methods known to those skilled in the art may also be used to secure the blades (22) to the housing (20) including, but not limited to, wire wrapping, cold forming, hot staking, insert molding, and adhesives. The housing (20) includes a skin contacting bar (40) positioned adjacent the elongated skin contacting element (60). The skin contacting bar (40), as illustrated in FIG. 1, has a generally rectangular cross section, but any number of cross sectional shapes are possible, such as a circle, square, triangle, or oval. As will be described in greater detail below, the elongated skin contacting element (60) may have one or several discrete arrays of skin contacting members (80 and 90) to facilitate localized stretching and/or orientation of hair.

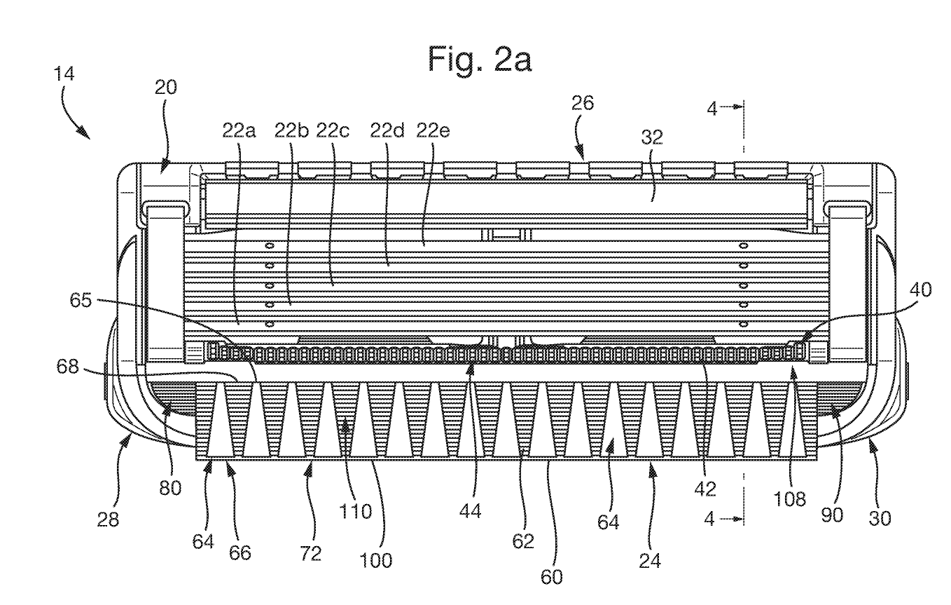

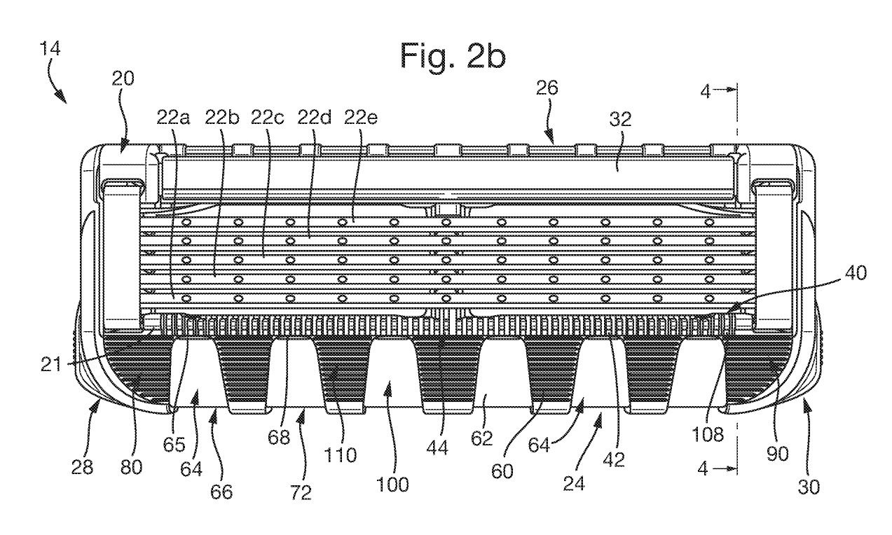

Referring to FIG. 2, a top plan view of the cartridge (14) is shown. The housing (20) may have a proximal end portion (24), a distal end portion (26), a first lateral end portion (28), and a second lateral end portion (30). The cap (32) may be disposed at the distal end portion (26) of the housing (20) and may include a lubricating strip which is secured to the housing (20). The skin contacting bar (40) is disposed at the proximal end portion (24) of the housing (20) directly adjacent to the first blade (22a) and adjacent the elongated gap (108) and the elongated skin contacting element (60). The skin contacting bar (40) is separated from the elongated contacting element (60) by the elongated gap (108) not shown here and described in more detail hereinafter. The blades (22a-22e) may each have a respective blade edge that cuts the hair passing from the skin contacting bar (40). The edge of the first blade (22a) may be spaced apart from the skin contacting bar (40) by distance of about 0.40 mm, 0.50 mm, or 0.60 mm to about 0.75 mm, 1.25 mm, or 1.5 mm. The design of the skin contacting bar (40) may allow for a larger or smaller distance between the skin contacting bar (40) and the edge of the first blade (22a). In certain embodiments, the spacing between the skin contacting bar (40) and the edge of the first blade (22a) may be less than about 0.05 mm and the skin contacting bar (40) may even touch the edge of the first blade (22a) for improved safety.

The skin contacting bar (40) may extend longitudinally from the first lateral end portion (28) to the second lateral end portion (30) of the housing (20). A plurality of generally rigid projections (42) may extend along the skin contacting bar (40) generally perpendicular to the first blade (22a). The generally rigid projections (42) may be integral with or secured separately to the skin contacting bar (40). The generally rigid projections (42) may be spaced apart to define an open channel (44). The generally rigid projections (42) may be disposed along a substantial length of the skin contacting bar (40). Alternatively, the generally rigid projections (42) may extend along only certain sections of the skin contacting bar (40), such as in a middle portion or at the lateral end portions (28 and 30). The relatively large number of generally rigid projections (42) over the length of the skin contacting bar (40) may better distribute forces applied by the skin contacting bar (40) to the skin surface, especially if the skin contacting bar (40) is made from a generally rigid material. In certain embodiments, the skin contacting bar (40) may have about 20, 30, or 40 to about 60, 70, or 80 generally rigid projections (42), depending on the pitch and length of the skin contacting bar (40). In one embodiment the skin contacting bar may have from about 45 to about 65 generally rigid projections, or from about 50 to about 60 generally rigid projections and consequently the skin contacting bar (40) may have about 21, 31, or 41 to about 61, 71 or 81 corresponding skin contacting bar land portions in-between. In one embodiment the skin contacting bar (40) has 55 skin contacting bar land portions and 54 rigid projections (42). The greater number of generally rigid projections (42) may also allow more hairs to pass between adjacent generally rigid projections (42), which may increase the number of hairs that are properly oriented prior to reaching the first blade (22a). The generally rigid projections (42) may have a pitch of about 0.20 mm, 0.40 mm, or 0.60 mm to about 0.8 mm, 1.0 mm, or 1.2 mm.

The skin contacting bar (40) may be integral with the housing (20) or may be secured to the housing (20) using mechanical, thermal or chemical manufacturing processes. The skin contacting bar (40) may be injection molded from a semi-rigid polymer material. A stiff or rigid material may allow the housing (20) to maintain a consistent geometry during shaving and enhance the ability of the generally rigid projections (42) to lift and orient hairs. The skin contacting bar (40) may be of sufficient stiffness such that the generally rigid projections (42) do not bend or flex under normal shaving conditions, which may adversely influence shave geometry. In certain embodiments, the skin contacting bar (40) may be molded from the same material as the housing (20), for example, Noryl™ (a blend of polyphenylene oxide (PPO) and polystyrene developed by General Electric Plastics, now SABIC Innovative Plastics). The skin contacting bar (40) may be molded from other semi-rigid polymers preferably having a Shore A hardness of about 50, 60, or 70 to about 90, 110, or 120. In alternative embodiments, a segmented dynamic flexing cartridge may be provided having one or more skin contacting bars (40) each having one or more generally rigid projections (42).

The elongated skin contacting element (60) is disposed at the proximal end portion (24) of the housing (20) directly adjacent the elongated gap (108) and the skin contacting bar (40). The elongated skin contacting element (60) extends longitudinally from the first lateral end portion (28) to the second lateral end portion (30) of the housing (20). The skin contacting bar (40) and the elongated skin contacting element (60) are spaced apart by an elongated gap (108) which is generally parallel to said skin contacting bar (40) and said elongated skin contacting element (60). The elongated skin contacting element (60) has a first proximal end portion (72) and a first distal end portion (70), preferably the first proximal end portion (72) is substantially coincident with the edge of the proximal end portion (24) of the housing (20).

The elongated skin contacting element (60) is provided with from 2 to 30, or from 2 to 20, preferably from 4 to 20 or from 14 to 20 or from 16 to 18, or in an alternative embodiment from 2 to 9 or alternatively from 4 to 8 discrete fluid pathway channels (62), preferably extending generally perpendicular to said blade(s) (22) or blade array. Typically, the channels extend from the first proximal end portion (72) to the distal end portion (70), thereby creating a fluid pathway through the entire width of the elongated skin contacting element (60). In a preferred embodiment, the first proximal end portion (72) is coincident with the edge of the proximal end portion (24) of the housing. Consequently, in use, fluid present on the skin surface will enter the fluid pathway channels in the cartridge and flow towards the blade array. The pathways are generally spaced equidistant apart from one another. Each respective channel (62) has a fluid inlet (64) and fluid outlet (65). The channels are formed by grooves or conduits extending from the skin contacting surface of the elongated skin contacting element towards the non skin contacting surface to thereby provide a defined discrete pathway to contain and transport fluid from the fluid inlet to the fluid outlet thereof. Typically, the channels (62) have a pitch of about 1.5 mm to 6 mm or alternatively from about 1.9 mm to about 5.5 mm and a depth of from about 0.1 mm to 4 mm, or from 0.1 mm to 2 mm or alternatively from about 0.7 mm to about 1.5 mm. The depth of the channels may be uniform throughout the length of the channel or it may be variable. The skin contacting surface area of the channels and the land portion in-between may be substantially identical or different. Each channel extends from the first proximal end portion (72) through the elongated resilient skin contacting member 60 to the first distal end portion (70) of the elongated skin contacting member (60). The fluid inlets (64) of said channels (62) are coincident with the edge of the proximal end portion (24) edge of said housing. In one embodiment the elongated skin contacting element (60) comprises 6 channels (62), wherein each of said channels has a channel inlet (64) diameter of 1.1 mm and has a channel outlet (65) of 0.3 mm.

It has been found that the provision of the channels (62) to provide a discrete and distinct fluid pathway as the fluid contacts the proximal end portion (24) of the housing and enters the elongated skin contacting element (60) at the respective fluid inlets, travelling through the elongated skin contacting element, thereby enables the desired fluid to be delivered to the blade array without necessitating modification of the skin contacting surface of the elongated skin contacting element (60) for that purpose and thereby reducing the efficacy of the skin stretch functionality thereof.

In particular the combination of elongated skin contacting element (60), having channels (62) and a land portions comprising skin stretching means such as an array of skin contacting members, together with the skin contact bar (40) and elongated gap (108), facilitate the continuous flow of lubricant to the blades while ensuring the desired skin stretch and hair management and orientation before the blades to ensure a close and comfortable shaving experience without irritation.

Each channel inlet for fluid entry (64) is typically located in the first proximal end portion (72) of the elongated resilient skin contacting member (60) and is coincident with the edge of the proximal end portion (24) edge of said housing. Similarly, each channel outlet (65) for fluid exit is located in the first distal end portion (70). Each channel inlet may independently have a substantially tapered edge. Each channel inlet for fluid entry (64), channel (62), and channel outlet (65) together form a fluid pathway to enable the flow of liquid through the elongated skin contacting member (60) and to exit therefrom to the elongated gap (108).

The channels inlets (64) are located on the front peripheral edge (66) of the first proximal end portion (72) of the elongated skin contacting element (60) and are coincident with the front edge of said housing. This ensures that there are no obstructions to the fluid entering the channels (62). For embodiments where the presence of a lubricating member is desirable at the proximal end portion (24) of the housing (20), such lubricating member is provided with channels corresponding to the elongated skin contacting element (60) channels (62) so as to enable the flow of fluid through the lubricating member to the channel inlet or the lubricating member is located below the channel inlets.

In another embodiment the channel outlets (65) may be located on the rear peripheral edge (68) of the first distal end portion (70) and preferably are adjacent said elongated gap (108). The channel inlets (64) and channel outlets (65) may independently have a chamfered and or tapered edge. The front and rear peripheral edges (66 & 68) of the elongated skin contacting element (60) may be substantially perpendicular to the blade (22) plane or may be at an angle thereto. The channel inlets (64) and channel outlets (65) are preferably located such that fluid can flow freely into the channels without any obstruction.

In one embodiment one of more of the channels (62) may be provided with at least 2 or more channel inlets (64) which supply the fluid to the channel (62).

The channels (62) may have any shape or size, but are typically substantially parti-cylindrical, tubular, or truncated cone or truncated pyramid in shape and may be identical, similar, or different in size and shape and may be symmetrical or asymmetrical. In the x axis plane the channels are typically quadrilateral for example rectangular, or trapezium. Preferably, the channels (62) do not have any angular corners or edges to facilitate fluid flow, particularly of viscous compositions through the channels (62). Each channel may independently have a channel diameter or major axis of from about 0.3 mm to about 5.0 mm or from about 1.0 mm to about 2.5 mm. In one embodiment the channel diameter or major axis is substantially uniform along the entire length of the channel. In another embodiment the channel diameter or major axis at the channel inlet (64) may be greater or less than the channel outlet (65). In one embodiment the channel inlet (64) diameter or major axis is greater than the diameter or major axis of the corresponding channel outlet (65), preferably at a ratio of from 10:1, or more preferably from 5:1. The diameter or major axis of the channel outlet (65) may be from 0.2 mm to about 2.0 mm or from about 0.4 mm to 0.9 mm. The diameter or major axis of the channel inlet (64) may be from 1.0 mm to about 5.0 mm or from about 1.5 mm to 3.1 mm. In one embodiment, the channel may be tapered or graduated through a portion of its length. For example the channel inlet (64) and/or outlet (65) may each independently have a funnel or funnel like shape. Such configurations aid the transport of the fluid through the elongated skin contacting element (60) towards and into the elongated recess to thereby ensure the delivery of the fluid to the blades.

The channels have a length that substantially corresponds to the length of the elongated skin contacting element (60) and is typically from about 2.0 mm to about 8.0 mm, preferably from about 3.0 mm mm to about 6.0 mm. In an alternative embodiment at least one or a plurality of the channels may extend beyond the elongated resilient skin contacting element (60) towards the elongated gap (108). The channel outlet (64) may be adjacent to or also extend into the elongated gap (108) in order to ensure that the fluid accumulates therein prior to passing through the blade array.

Each channel may independently have a volume of from about 2.0 mm³ to 8.0 mm³, or from about 3.0 mm³ to about 6.0 mm³.

The channels may each independently provide a straight, curved, or angular fluid pathway from the fluid inlet (64) to the fluid outlet (65). The channel pathway may be substantially perpendicular to the blade array. The fluid pathway may be located to be substantially parallel to the skin contacting surface of the elongated skin contacting member (60). In another embodiment the fluid pathway of the channels may independently extend towards the skin contacting surface of the elongated skin contacting member in a linear or curved configuration.

The channels (62) may be formed as a single structure for example within a single elongated resilient skin contacting member (60) or may be formed from separate components which are assembled to form the channels and optionally the elongated skin contacting element (60). In one embodiment at least a portion of the channel(s) may be formed from a secondary component. In another embodiment at least a portion of the channel(s) may be formed by the insertion of a secondary structure into the elongated resilient skin contacting element (60). In another embodiment the channels may be formed from the combination of the elongated skin contacting element (60) and the housing (20) or a portion of the housing (20).

In another embodiment, the channels (62) may become deformed during cartridge use as the elongated skin contacting element (60) is pressed against the user's skin. Such deformation may enable the channels to function as a pump to thereby pump the fluid through the channels (62) as the pressure against the skin is increased and decreased as the cross sectional diameter or major axis decreases.

In certain embodiments, the channels (62) may be molded from the same material as the housing (20) and/or the elongated skin contacting element (60). Suitable materials include for example, Noryl™ (a blend of polyphenylene oxide (PPO) and polystyrene developed by General Electric Plastics, now SABIC Innovative Plastics). The channels (62) and/or elongated skin contacting element (60) may be molded from other semi-rigid polymers preferably having a Shore A hardness of from about 30, 40, 50, 60, or 70 to about 90, 110, or 120. The channels and/or elongated skin contacting element (60) may alternatively be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend), or may comprise Kraiburg HTC 1028/96, HTC 8802/37, HTC 8802/34, or HTC 8802/11 (KRAIBURG TPE GmbH & Co. KG of Waldkraiburg, Germany). The skin contacting element (60) is preferably elastic and or resilient.

The channels may be formed using known manufacturing techniques such as injection molding, ultrasonic welding, and the like.

The elongated skin contacting element (60) further comprises corresponding land portions (63) in-between said channels. Thus the elongated skin contacting element comprises from 1 to 31 land portions, or 1 to 21 land portions or 13 to 21 land portions or 3 to 9 land portions. At least one land portion and preferably each of said land portions may comprise at least one skin stretching means as described hereinafter. The land portions may provide a total skin contacting surface area which is substantially the same as that of the total skin contacting surface area of the channels or it may be different. In this manner the degree of skin stretching provided by the razor cartridge maybe altered according to the particular consumer need.

Suitable skin stretching means for use on the land portions of the elongated skin contacting element includes at least one skin contacting member, such as a plurality of distinct arrays of skin contacting members; a structure or coating material to increase friction; a plurality of three dimensional microstructures; a structure or coating material to modulate friction and combinations thereof.

The elongated skin contacting element (60) may comprise at least one skin contacting member, preferably a plurality of distinct arrays of skin contacting members (80 and 90). The arrays of skin contacting members (80 and 90) can have different sizes, shapes, and geometries. In particular, the arrays of skin contacting members (80 and 90) can be in the form of nubs or fin segments that are spaced apart or interconnected. The arrays of skin contacting members (80 and 90) may also have different patterns or may be oriented at different angles with respect to the blades, e.g., in zigzag, chevron, herringbone, parallel or checkerboard patterns. The arrays of skin contacting members (80 and 90) can also take the form of spaced fin segments that are arranged in rows oriented generally parallel to the blades or spaced fin segments that are arranged both parallel to and perpendicular to the blades. In one embodiment the array of skin contacting members (80 and 90) are arranged on each land portion of the skin contacting element (60) and comprise substantially identical patterns of spaced fin segments arranged substantially parallel to the blades.

In one embodiment the land portions of the elongated skin contacting element (60) may define at least 2 distinct areas on at least one land portion (63), preferably all of the land portions (63). The land portion may have a first distinct area located towards the front peripheral edge (66) of the elongated skin contacting element (60) and a second distinct area located towards the rear peripheral edge (68) of the elongated skin contacting element (60). The first and second distinct areas comprise different skin stretching means. For example the first distinct area may comprise a coating material to modify friction whereas the second distinct area may comprise an array of skin contacting members such as fins arranged in a regular pattern or vice versa. Alternatively the first and second distinct areas may comprise two distinct arrays of skin contacting members. The provision of such distinct areas may further aid providing consumer desirable skin stretch.

In certain embodiments, the elongated skin contacting element (60) may be insert injection molded or co-injection molded to the housing (20), however, other known assembly methods may also be used such as adhesives, ultrasonic welding, or mechanical fasteners. The elongated skin contacting element (60) and the array of skin contacting members (80 and 90) may be molded from a softer material than the skin contacting bar (40). For example, the elongated skin contacting element (60) and the array of skin contacting members (80 and 90) may have a Shore A hardness of about 20, 30, or 40 to about 50, 60, or 70. In one embodiment the elongated skin contacting element (60) is resilient. The elongated skin contacting element (60) and the array of skin contacting members (80 and 90) may be made from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs (e.g., Kraton), polyester TPEs (e.g., Hytrel), polyamide TPEs (Pebax), polyurethane TPEs, polyolefin based TPEs, and blends of any of these TPEs (e.g., polyester/SEBS blend). In certain embodiments, the elongated skin contacting element 60 and the array of skin contacting members (80 and 90), may comprise Kraiburg HTC 1028/96, HTC 8802/37, HTC 8802/34, or HTC 8802/11 (KRAIBURG TPE GmbH & Co. KG of Waldkraiburg, Germany). A softer material may enhance skin stretching, as well as provide a more pleasant tactile feel against the skin of the user during shaving. A softer material may also aid in masking the less pleasant feel of the harder material of the housing (20) and/or the skin contacting bar (40) against the skin of the user during shaving.

The land portion(s) of the elongated skin contacting element (60) may comprise any structure or coating to increase or modulate the friction thereof in order to effectively engage with and stretch the skin. In one embodiment the elongated skin contacting element (60) may comprise a plurality of three dimensional microstructures. The three dimensional shapes can comprise polyhedrons, hemispheres, cones, cubes, cylinders and combinations thereof. The structures may be close packed or oriented at a distance from one another. The structures can be formed from a base substrate alone or a base structure with a coating wherein the coating partially or totally covers the base substrate. The base substrate can comprise materials selected from the materials listed hereinabove and materials such as polyurethane, aluminium, polypropylene, steel, glass acrylic, polyimide, polyetheretherketone, biopolymer or combinations thereof. In certain embodiments the base structure may comprise materials to enable the high friction microstructures to wear away and signal the end of a cartridge life. The coating may act to modulate the friction or aesthetic appearance of the base substrate or act as a barrier between the skin and the base substrate or a combination thereof. The base structure and coating may be joined to the housing using a number of conventionally known attachment mechanisms including, but not limited to, adhesive, injection molding, ultrasonic bonding, bonding, insert molding, over molding or combinations thereof.

In one embodiment the land portions of the elongated skin contacting element in the presence of absence of an array of skin contacting members and/or three dimensional microstructures, may be coated with a material to modulate friction. In wet shaving hydrophobic or omniphobic surfaces would generally be chosen to provide this benefit. Any suitable route for creating this coating can be considered including chemical bonding (ionic or covalent), physi sorption of suitable moieties. Examples of such techniques would be hydrophobic polymer brushes via ATRP reaction chemistry or liquid infused porous surface e.g. SLIPS. Preferably the coating technique is chosen to be able to withstand the aggressive conditions that the skin contacting surface may be exposed to during use.

In one preferred embodiment of the present invention, the elongated skin contacting element comprises 17 channels regularly disposed thereon evenly and 18 corresponding land portions in-between and at each end thereof. Each of the channel inlets has a diameter of 1.1 mm and a channel outlet diameter of 0.43 mm. The channel pitch is 1.9 mm. Each channel has a convex base and has a depth of 1.1 mm at the channel inlet and 0.7 mm at the channel outlet. Each of the land portions has a lateral array of skin contacting members in the form of 12 fins.

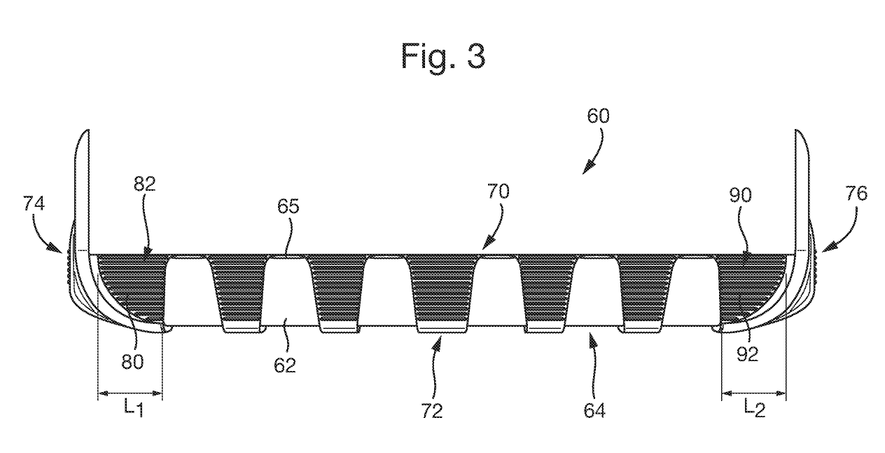

Referring to FIG. 3, a top plan view of the elongated skin contacting element (60) is shown. The elongated skin contacting element (60) may include a distal end portion (70), a proximal end portion (72), a first lateral end portion (74) and a second lateral end portion (76). The elongated skin contacting element (60) may include one or more lateral arrays of skin contacting members In addition to the skin contacting members present on the land portions thereof, a lateral array of skin contacting members may be disposed at the first lateral end portion (74) and another lateral array of skin contacting members may be disposed at the second lateral end portion (76) of the elongated skin contacting element (60). The lateral arrays of skin contacting members may have a similar pattern, such as one or more flexible skin-engaging projections (82 and 92) that extend generally parallel to the blades. One lateral array of skin contacting members may have a length L₁ that extends from the first lateral end portion (74) towards the second lateral end portion (76). In certain embodiments, L₁ may be about 0.5 mm, 1 mm, or 3 mm to about 5 mm, 7 mm, or 9 mm. The other lateral array of skin contacting members (90) may have a length L₂ that extends from the second lateral end portion (76) towards the first lateral end portion (74). In certain embodiments, L₁ and L₂ may be generally the same, for example, L₂ may be about 0.5 mm, 1 mm, or 3 mm to about 5 mm, 7 mm, or 9 mm. The lengths L₁ and L₂ may provide for increased skin stretching at the first and second lateral end portions (74) and (76) relative to an area between the first and second lateral end portions (74 and 76). A force applied by the elongated resilient skin contacting element 60 to the surface of the skin may not be uniform along its entire length. Additional skin stretching may be needed at the lateral end portions (74 and 76) of the elongated skin contacting element (60) to provide for a more uniform skin stretching profile along the length of the elongated skin contacting element (60). A more uniform skin stretching profile may result in a more consistently close and comfortable shave along the entire length of the cartridge (14), rather than a close and comfortable shave along only certain areas of the cartridge (14).

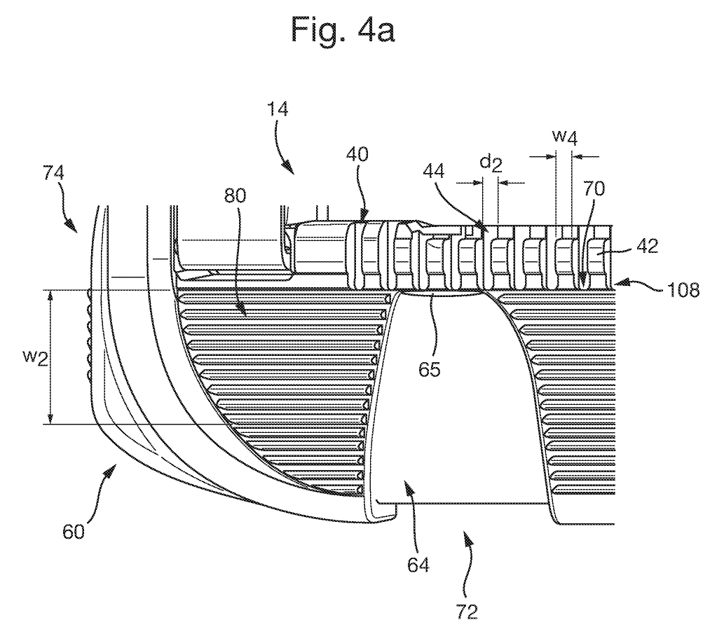

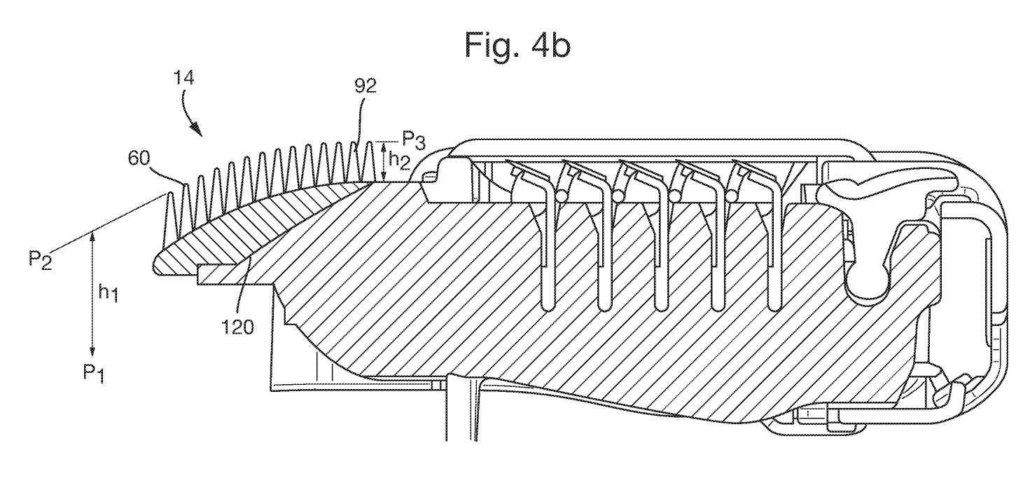

Referring to FIG. 4A, an enlarged partial top plan view of the cartridge (14) is shown. Typical guards only have a single pattern that is either traverse to the direction of shaving (which is not optimal for skin stretching) or is parallel to the shaving direction (which is not optimal for hair alignment and may remove too much shave preparation). The elongated skin contacting element 60 may have several distinct arrays of skin contacting members (80 and 90) which can be used in combination with the skin contact bar (40) to provide an optimum balance of skin stretching and proper hair alignment.

The elongated gap (108) may extend generally the length of the skin contacting bar (40), but may be shorter if desired. The elongated gap (108) may be provided to facilitate the release of any hair that might be pressed against the surface of the skin back to a more upright orientation as the hair passes to the skin contacting bar (40). The elongated gap (108) may have a width of about, 0.1 mm or 0.2 mm to about 0.3 mm, 0.4 mm, or 0.5 mm. In certain embodiments, the elongated gap (108) may extend continuously along the length skin contacting bar (40) or the elongated gap (108) may include segments that extend in a discontinuous manner along the length of the skin contacting bar (40). The elongated gap may have a depth of at least 0.1 mm and a width of at least 0.1 mm.

The generally rigid projections (42) of the skin contacting bar (40) may facilitate the management of skin and the guiding of hair to the first blade. The generally rigid projections (42) may also facilitate the lifting of hairs from the surface of the skin. Adjacent generally rigid projections (42) may be spaced apart to define the open channel (44) that is dimensioned to facilitate the generally unobstructed passage of hair to the first blade with minimal pulling or tugging of the hair, which may result in discomfort. The open channels (44) may also be dimensioned to reduce skin bulges and pressure points at ends of the generally rigid projections (42), which may result if the spacing is too great between adjacent generally rigid projections (42). For example, if the generally rigid projections (42) are spaced too far apart, skin may bulge into the open channel (44) which may result in the skin being unnecessarily sliced or cut by one or more of the blades. In certain embodiments, the generally rigid projections (42) may be spaced apart (i.e., the open channel 44) by a dimension “d₂” of about 0.10 mm, 0.20 mm or 0.30 mm to about 0.35 mm, 0.40 mm, or 0.49 mm, however d₂ may be larger or smaller depending on the thickness and amount of hair passing through the open channels (44). Improper spacing may result in discomfort caused by pressure points, skin bulges and/or the pulling of hair.

The generally rigid projections (42) may be sufficiently rigid such that the geometry of the open channels (44) remains consistent during shaving, thus maintaining optimum blade-skin geometry resulting in a closer and more comfortable shave. A top face of the skin contacting bar (40) may be generally flat for improved management of skin flow and increased comfort. In certain embodiments, the generally rigid projections (42) may have a width “w₄” that is generally equivalent to d₂. For example, the w₄ may be about 0.10 mm, 0.20 mm, or 0.30 mm to about 0.35 mm, 0.40 mm, or 0.49 mm, however w₄ may also be larger or smaller depending on the desired total contact area with the skin surface The dimensions of generally rigid projections 42 and, the open channels 44, may allow for an optimal balance of skin management, comfort, hair orientation, and rinsability.

Referring to FIG. 4B the flexible skin-engaging projections 82 (not shown), 92 , may extend from a base (120) of the elongated resilient skin contacting element (60). The base (120) may be inclined along a generally curved plane P1. A top surface of the flexible skin-engaging projections (92) may be oriented along a generally inclined curved plane P2. The flexible skin-engaging projections (92) may have a height h₁, as measured from P1 to P2, of about 0.25 mm, 0.50 mm, or 0.75 mm to about 1.0 mm, 1.25 mm, or 2 mm. A top surface of the flexible skin-engaging projections (92) may be oriented along a generally inclined curved plane P3. The flexible skin-engaging projections (82 and 92) may have a height h₂, as measured from P1 to P3, of about 0.1 mm, 0.25 mm, or 0.5 mm to about 0.75 mm, 1.0 mm, or 1.5 mm. In certain embodiments, h₁ may be greater than h₂, to provide the flexible skin-engaging projections (92) with increased flexibility and skin stretching properties. It is understood that due to the possible inclines of planes P1, P2 and P3, the height (h1, h2 and h3) of the individual flexible skin-engaging projections 82 (not shown) and 92 and 102 may vary along the elongated resilient skin contacting element (60).

Shaving Aid

The razor cartridge may further comprise a lubricating strip or shaving aid comprising a lubricant, or lubricating material. The lubricating material can be in various forms, as well as mixtures/combinations thereof, as will be described below. The lubricating strip may be located in front or behind of the blades (22) and may be statically or spring mounted on the housing (20). A lubricating member can be comprised of any solid chemistry on a razor cartridge and is often referred to as a shaving aid. The shaving aid on a razor cartridge is often in the form of a strip and is referred to as a lubrastrip. Lubrastrips are typically in the form of a water insoluble structurant or matrix polymer such as ethylene-vinyl acetate (EVA) or high impact polystyrene (HIPS) and a water soluble lubricant such as a high molecular weight polyethylene oxide. Other forms of shaving aid include but are not limited to soaps and other lubricating chemistries which can be produced by hot molding, injection molding, extrusion or other processes known in the art.

In the case of a matrix of high molecular weight polyethylene oxide and high impact polystyrene the high impact polystyrene serves as the supporting structure for the lubricating strip and the high molecular weight polyethylene oxide serves as the lubricating component. Examples of suitable lubricating members are described in U.S. Pat. No. 7,811,553; U.S. 2008/0060201A1; U.S. 2009/0223057 A1; and GB 2138438B.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising a housing having a proximal end portion, a distal end portion, and first and second lateral end portions, and at least one blade positioned between said proximal and distal end portions; said housing comprising;
i) a skin contacting bar in front and adjacent said blade, wherein said skin contacting bar has a plurality of rigid projections extending generally perpendicular to said blade,
ii) an elongated gap adjacent said skin contacting bar and generally parallel to said skin contacting bar; and
iii) an elongated skin contacting element adjacent said elongated gap wherein said elongated skin contacting element has from about 2 to about 30 discrete fluid pathway channels, preferably extending generally perpendicular to said blade, each channel having a fluid inlet and fluid outlet and corresponding land portions in-between said channels, wherein at least one of said land portions, preferably each of said land portions comprises at least one skin stretching means and wherein said fluid inlets of said channels are coincident with the edge of the proximal end portion of said housing.

2. A razor cartridge according to claim 1, wherein said elongated skin contacting element comprises from about 4 to about 20 of said channels.

3. A razor cartridge according to claim 1, wherein said elongated skin contacting element has a first proximal end portion and a first distal end portion and wherein said fluid inlets of said channels are located in said first proximal end portion and said fluid outlets are located in said first distal end portion.

4. A razor cartridge according to claim 1, wherein each of said channels independently has a diameter or major axis of from about 0.3 mm to about 5.0 mm.

5. A razor cartridge according to claim 1, wherein each of said channels has a depth of from about 0.1 mm to about 4.0 mm.

6. A razor cartridge according to claim 1, wherein the ratio of the channel inlets diameter to the channel outlets diameter is about 10:1.

7. A razor cartridge according to claim 1, wherein each of said channels have a length of from about 2 mm to about 8 mm.

8. A razor cartridge according to claim 1, wherein at least one of said channel outlet extends into said elongated gap.

9. A razor cartridge according to claim 1, wherein said channels have a volume of about 3 mm³ to about 6 mm³.

10. A razor cartridge according to claim 1, wherein at least one skin stretching means is selected from at least one skin contacting member, preferably a plurality of distinct arrays of skin contacting members; a structure or coating material to increase friction; a plurality of three dimensional microstructures; a coating material to modulate friction and a combination thereof.

11. A razor cartridge according to claim 1, wherein said skin stretching means comprises a plurality of distinct arrays of skin contacting members.

12. A razor cartridge according to claim 1, wherein each of said land portions comprises a skin stretching means.

13. A razor cartridge according to claim 1, wherein said housing further comprises at least one shaving aid.

14. A razor cartridge according to claim 1, wherein said elongated gap has a width of about 0.2 mm to about 0.5 mm and preferably extends the length of the skin contacting bar.

15. A razor cartridge according to claim 1, wherein said channel inlets have a diameter of from about 1.0 mm to about 5 mm and said channel outlets have a diameter of from about 0.2 mm to about 2.0 mm.

16. A razor cartridge according to claim 1, wherein the channel inlet diameter is greater than the channel outlet diameter, preferably wherein the ratio of the diameter of the channel inlet to channel outlet is about 10:1.

17. A razor cartridge according to claim 1, wherein said elongated skin contacting element comprises 6 channels, wherein each of said channels have a channel inlet diameter of about 1.1 mm and a channel outlet of about 0.3 mm.
